(19) United States
(12) Patent Application Publication
(10) Pub. No.: US 2003/0078904 A1
(43) Pub. Date: Apr. 24, 2003

(54) Work in process control

(76) Inventors: Timothy Michael Meyers, Fairfield, OH (US); Barry L. Templin, Terre Haute, IN (US); Steven John Anneken, Cincinnati, OH (US); Joyce Elaine Meyer, West Chester, OH (US)

Correspondence Address: GENERAL ELECTRIC COMPANY, ANDREW C HESS, GE AIRCRAFT ENGINES, ONE NEUMANN WAY M/D H17, CINCINNATI, OH, 452156301

(21) Appl. No.: 09/982,756

(22) Filed: Oct. 18, 2001

(51) Int. Cl. G06F 7/00

(52) U.S. Cl. 707/1

(57) ABSTRACT

An internet-based system and method are provided for allowing component parts to be tracked by internal users and external users. A database is configured with component parts data, for housing part information. The database further operates with a repository for tracking part location through each step within the work in process, and positively affecting the total time required for a work in process.

### BACKGROUND OF THE INVENTION

The present invention relates to work in process controls and, more particularly, to the ability to locate an individual part to its exact location while a work is in process.

Currently, many industries receive parts from vendors and customers, and use the parts in repair and refurbishment. As the parts move through the repair and refurbishment cycle, it is often difficult to precisely locate an individual part to its exact location without excessive manpower. Typically, a manual check has been required on day-to-day orders. In the airline industry, for example, when an engine overhaul shop is inventorying parts, there are literally thousands of parts attributable to a single engine or work in process. Consequently, parts can be held for prolonged periods of time, awaiting completion of necessary prior steps in a cycle.

Each customer, overhaul site or repair facility has its own system for documenting the parts within their facilities. Some of these systems are detailed, listing most of the information required to determine a near-exact location of a part. Other systems are less detailed, and lack the information needed to precisely locate an individual part. Due to the lack of a common system of documenting, communicating, and following parts, the opportunity to efficiently schedule manpower and predict shipping orders on time may be missed.

It would be desirable to provide a database that would provide the ability to locate an individual part to its exact location without excessive manpower. It would also be desirable to more efficiently predict shipping orders and schedule manpower based on the location of parts in the repair or production cycle.

### BRIEF DESCRIPTION OF THE INVENTION

A component location database is proposed for tracking part location of each individual part in a system to its exact location. The database can serve as a hub for marrying part location and repair/production needs with employee vouchering to a particular part. The database can house data to enable targeted location of any individual part in a system.

Accordingly, the present invention provides a central database for housing part information. The database further operates as a repository for tracking part location through each step within the work in process, and positively affecting the total time required for a work in process.

### BRIEF DESCRIPTION OF THE DRAWING

FIG. 1 is a schematic block diagram illustrating the operation of the part tracking technique of the present invention; and

FIG. 2 is a system diagram illustrating the steps for tracking parts through a work-in-process.

### DETAILED DESCRIPTION OF THE INVENTION

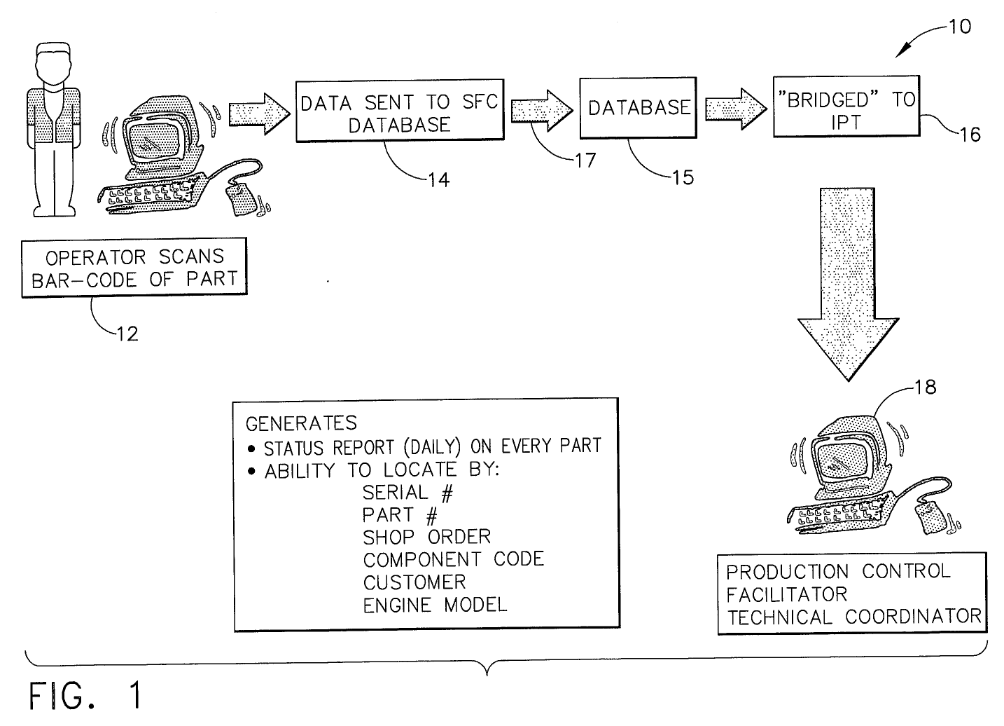

Referring to FIG. 1, there is a schematic block diagram 10 illustrating a database structure 10 for storing accessible details on parts and related repair or refurbishment needs. The system 10 comprises at least one operator 12. The operator scans a bar code of an incoming part and sends the data to a shop floor control database, as at block 14. Each operator 12 will typically have access only to its own listing created by its own bar code scans of parts. The bar code scan can provide relevant part information, such as for example, the serial number and part number of the part, the shop order, the component code, and the engine or final production model of the part, as well as identifying the customer. Additional information can also be provided, as needed, by the bar code scan.

The invention is described herein as a database for tracking parts, particularly throughout a work in process. It will be obvious to those skilled in the art, however, that the tracking concept of the present invention can be applied to a multitude of engineering or development type systems without departing from the scope of the invention.

Continuing with FIG. 1, the structure of the system 10 allows for each operator 12 to submit bar code scans of parts to a database via block 14. The data is then sent to database 15 via interface 17. The database can be configured to store and download text and digital images. The database 15 can provide real time information on part location and repair or refurbishment decisions relating to the part. The data is then bridged from the shop floor control to an in-plant tracking system, as at block 16. The in-plant tracking system generates a status report to a user at location 18, on a regular schedule such as daily, or on demand, on every part. The status report can be in graphical and/or text format. The tracking system of the present invention also provides the ability to locate the part by any of the individual bar code data information, within seconds. In addition to the increased ability to precisely locate parts, scheduling of manpower and predictions of shipping orders is easier and more accurate with the present invention.

Communication with the database 15 can comprise any kind of digital communication network or combination of digital communication networks. For example, the communication can be by means of a web browser, local area network (LAN), wide area network (WAN), World Wide Web, or any combination of these networks. Likewise, the operator links 12 and the user links 18 can be of any form so long as the inputting of information, requests for information, and retrievability of information can be communicated between each link 12 or 18 and the database 15. The communication between the operator and the shop floor control, and the shop floor control and the in-plant tracking, and to the production control 18, can be implemented in any suitable form, such as a web server.

The database 15 provides an interface 17 that permits a user to input part data, and a production control 18 to receive a status report on every part. The database includes an input portion and an output portion. The input portion of the interface 17 is used to convey information from the operator 12 to the database 15. The output portion conveys information from the database 15 to the production control 18, and is typically displayed on a monitor at the production control. However, the output portion is capable of being displayed on other output peripherals, like printers. Typically, the input information is generated by the operator's actuation of an input peripheral, such as a mouse or a keyboard.

Although the configuration described herein refers to a database 15 being geographically and physically separated from each user link 12, this does not preclude integrating the data and information between database 15 and operator site 12 to create a stand-alone system. In such a case, it is feasible to use a network to update the information from database 15 resident in each of the operator computers 12. It is also feasible to download the information and data.

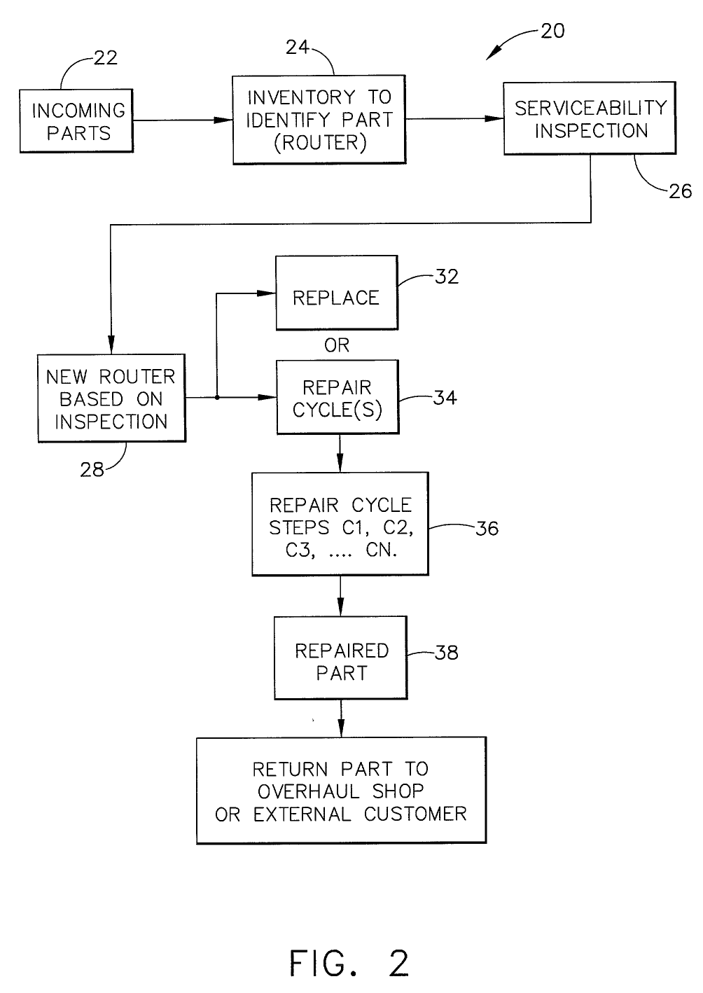

Referring now to FIG. 2, a schematic block diagram 20 is shown, illustrating a typical path followed by a part during a work in process. Initially multitudes of incoming parts, indicated at block 22, are received. Continuing to block 24, the parts are each inventoried to identify the part, such as by part number, serial number, model number, and/or final production item in which the part is used. A router can be created at block 24 to document the part inventory information, prior to the part receiving a serviceability inspection at block 26. Based on the results of the inspection, a new router can be generated at block 28.

Continuing with FIG. 2, the new router is used to determine the disposition of the part. The part can either be replaced at block 32, or enter a repair cycle at block 34. The repair cycle will typically comprise multiple cycle steps, C1 through CN, as indicated at block 36. As will be obvious to those skilled in the art, multiple, as many as thousands, of cycles 36 are occurring simultaneously and/or concurrently, and parts in multiple cycles are gathered after cycle step CN to be assembled into a larger component.

Currently, repair shops concentrate and manage part delivery in this final step of the cycle, at block 38 where a part is repaired. At block 40, the finished part is provided, for return to the overhaul shop or external customer shop, to be put back into the engine or other component from which it originated. The database of the present invention can track each part in each cycle through all of the cycle steps C1 through CN. Each step C1 through CN of each cycle requires some amount of time to complete. By following each part through each step of each cycle, decision makers can begin to understand where a part is in the overview of the entire work in process, and thereby shorten the time required for some parts to spend in one or more cycle steps. Consequently, part quantity in the production line can now be determined, pulling the management of part delivery out of the end of the work in process, and applying it throughout the work in process. Not only is control of hardware improved, flexibility of parts processing through the ability to access real time information on a part, increases.

With the tracking system of the present invention, all part data is deposited at the component database 15 of FIG. 1. This provides real time information on part location for all parts in need of repair or replacement. The parts are separated by repair or replacement needs at blocks 32 and 34 of FIG. 2. Consequently, the part database 15 provides a link or information to locate all parts to an exact location within the work in process cycle.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for storing component part data comprising:
a repository for collecting component part data input by an operator;
an interface for allowing updating of the component part data;
a database for storing information in the repository and receiving updated component part data from the operator; and
a link for providing component part location to a production control using information in the database.

2. A system as claimed in claim 1 wherein said operator comprises multiple operators.

3. A system as claimed in claim 2 wherein the database is owned by an owner entity.

4. A system as claimed in claim 3 wherein the multiple operators comprise operators internal to the owner entity and operators external to the owner entity.

5. A system configured for component hardware location and disposition tracking by internal users and external users, said system comprising:
a database of component hardware data, said database configured with an operator interface allowing an operator to input information into the database, and allowing a production control user to download information from the database including exact component hardware location data;
at least one operator computer;
at least one production control user computer; and
an interface between the at least one operator computer and the database, and the at least one production control user computer and the database.

6. A system as claimed in claim 5 wherein the component hardware location data is reviewed for potential engineering opportunities.

7. A system as claimed in claim 5 wherein access to said database is configured to be secured by user password.

8. A system as claimed in claim 5 wherein said operator comprises multiple operators.

9. A system as claimed in claim 8 wherein the database is owned by an owner entity.

10. A system as claimed in claim 9 wherein the multiple operators comprise operators internal to the owner entity and operators external to the owner entity.

11. A system as claimed in claim 9 wherein the database is configured to receive, categorize, and store component hardware data based on information provided by the internal and external operators.

12. A system as claimed in claim 5 wherein the interface is provided by web pages that can be transmitted from the database to the operator.

13. A system as claimed in claim 5 wherein the component hardware data comprises component part location.

14. A system as claimed in claim 5 wherein said database is configured to store and download text and digital images.

15. A system as claimed in claim 5 wherein the database is configured to receive, profile, track and store component hardware data.

16. A method for storing component part data comprising the steps of:
providing a repository for collecting component part data input by an operator;
using an interface to allow updating of the component part data;
providing a database for storing information in the repository and receiving updated component part data from the operator; and
linking component part location to a production control, using information in the database.

17. A method as claimed in claim 16 wherein said operator comprises multiple operators.

18. A method as claimed in claim 17 wherein the database is owned by an owner entity.

19. A method as claimed in claim 18 wherein the multiple operators comprise operators internal to the owner entity and operators external to the owner entity.

20. A method as claimed in claim 16 wherein the step of linking allows for display of digital and text images.
